(19) United States
(12) Patent Application Publication
(10) Pub. No.: US 2007/0154665 A1
(43) Pub. Date: Jul. 5, 2007

(54) Double-walled beverage container with design

(76) Inventor: Benjamin Cheng, Palos Verdes, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/321,095

(22) Filed: Dec. 29, 2005

(51) Int. Cl. B28B 11/00; B32B 27/08

(52) U.S. Cl. 428/34.4; 428/35.7

(57) ABSTRACT

A beverage container having a substantially cylindrical outer layer that may be translucent, a substantially cylindrical inner layer and an ornamental design comprising a first portion and second portion. The first portion of the ornamental design may be applied to the outside of the outer layer while the second portion may be applied to the inside of the outer layer. Additionally, the beverage container may comprise a removable top cover.

### BACKGROUND OF THE INVENTION

1. Field of the Invention

This invention relates to a beverage container. Particularly, a double-walled beverage container that may have a design applied to the inside and outside of the outer layer.

2. Description of the Related Technology

Many variations of beverage containers have been introduced in recent years. These containers have been made from various materials such as stainless steel, plastic, glass, and ceramic. Some beverage containers include ornamental designs and/or indicating elements. Other containers have been designed to be portable, e.g., by the inclusion of a handle and/or top cover. Additionally, several beverage containers have been designed to keep the liquids inside either hot or cold.

### SUMMARY OF CERTAIN INVENTIVE ASPECTS

An aspect of the invention is a beverage container comprising a substantially cylindrical outer layer, wherein the outer layer may be translucent; a substantially cylindrical inner layer; and an ornamental design comprising a first portion and second portion, wherein the first portion may be applied to the outside of the outer layer and wherein the second portion may be applied to the inside of the outer layer.

In one embodiment, the outer layer may be made of plastic such as polycarbonate, polyethylene, polyethylene terephthalate, polypropylene, polystyrene, polyvinyl chloride and mixtures thereof. In other embodiments, the outer layer may be made of glass or other suitable material(s).

Referring to inner layer, in one embodiment the inner layer may be made of plastic. Suitable plastics include polycarbonate, polyethylene, polyethylene terephthalate, polypropylene, polystyrene, polyvinyl chloride and mixtures thereof. In other embodiments, the inner layer may be made of glass or other suitable material(s). In some of the embodiments, the inner layer may be transparent. While in other embodiments, the inner layer may be opaque.

In one embodiment, at least a portion of the top of the inner layer may extend beyond the upper edge of the outer layer. In another embodiment, at least a portion of the top of the inner layer extending beyond the upper edge of the outer layer may be configured to engage the upper edge of the outer layer, e.g., at least a portion of the top of the inner layer extending beyond the upper edge may comprise a substantially cylindrical peripheral lip configured to engage the upper edge of the outer layer.

In other embodiments, the exterior bottom of the inner layer may be attached to the interior bottom of the outer layer.

With respect to the ornamental design, in some embodiments the first portion of the ornamental design may be applied by printing or silk-screening onto the outside of the outer layer. In other embodiments, the second portion of the ornamental design may be applied by printing or silk-screening onto the inside of the outer layer.

In one embodiment, the beverage container may further comprise a removable top cover. In another embodiment, at least a portion of the top of the inner layer extending beyond the upper edge of the outer layer and the removable top cover may comprise threads that allow for the top cover and the inner layer to be joined. In a different embodiment, the removable top cover may snap onto the upper edge of the inner layer. In still another embodiment, the removable top cover may comprise a dispensing aperture and a ventilation aperture. In yet another embodiment, the removable top cover may have a mechanism that opens and closes the dispensing aperture.

### BRIEF DESCRIPTION OF THE DRAWINGS

The invention is described herein with reference to the attached drawings. The drawings are merely illustrative, and in no way limit the invention to what is shown.

FIG. 1 is a perspective view of an embodiment of the beverage container with a removable top cover.

FIG. 2 is a cross-sectional view of the beverage container shown in FIG. 1 without a removable top cover.

FIG. 3A shows the assembly of the inner and outer layers of the beverage container with threads formed on the upper portion of the inner layer and the removable top cover.

FIG. 3B shows the assembly of the inner and outer layers of the beverage container with a removable top cover that snaps onto the upper lip of the inner layer.

FIG. 4A shows a top view of the removable top cover shown in FIG. 1.

FIG. 4B shows a bottom view of the removable top cover shown in FIG. 1.

### DETAILED DESCRIPTION OF CERTAIN INVENTIVE EMBODIMENTS

Referring to the Figures, the beverage container 1, in accordance with an embodiment of the invention, comprises a substantially cylindrical outer layer 10 that may be translucent, a substantially cylindrical inner layer 20 and an ornamental design comprising a first portion 30 and second portion 31. The first portion of the ornamental design 30 may be applied to the outside of the outer layer 11 while the second portion 31 may be applied to the inside of the outer layer 12.

In an embodiment, the substantially cylindrical outer layer 10 of the beverage container 1 may be made of plastic. Suitable plastics include polycarbonate, polyethylene, polyethylene terephthalate, polypropylene, polystyrene, polyvinyl chloride and mixtures thereof. However, if desired, the outside layer 10 may be made of glass or other suitable material(s).

Similar to the outer layer, the substantially cylindrical inner layer 20 may be formed from plastic, glass or other suitable material(s). Representative plastics that may be utilized include polycarbonate, polyethylene, polyethylene terephthalate, polypropylene, polystyrene, polyvinyl chloride and mixtures thereof. The inner layer 20 may be transparent or opaque. The ability to vary the inner layer 20 allows for the possibility of contrasting or complementing another part of the beverage container. This may make the beverage container more aesthetically pleasing and/or allow for the matching of the color scheme of the beverage container to a business' logo.

In one embodiment of the invention, at least a portion of the top of the inner layer 21 may extend beyond the upper edge of the outer layer 13. In another embodiment, at least a portion of the top of the inner layer 21 extending beyond the upper edge of the outer layer 13 may be configured to engage the upper edge of the outer layer 13. Such a configuration may be achieved in various ways. For example, at least a portion of the top of the inner layer 21 extending beyond the upper edge of the outer layer 13 may comprise a substantially cylindrical peripheral lip 22 configured to engage the upper edge of the outer layer 13. The substantially cylindrical peripheral lip 22 may also be configured in various ways. For instance, the substantially cylindrical peripheral lip 22 may extend out from the inner layer 20 so that the peripheral lip 22 rests on the top of the upper edge of the outer layer 13 when fully assembled.

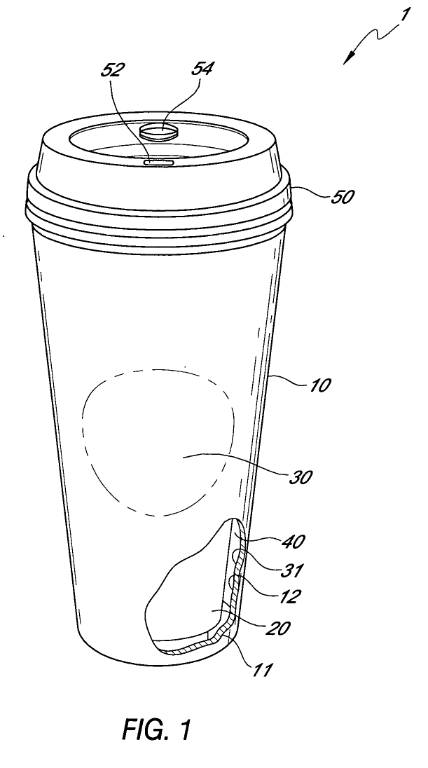

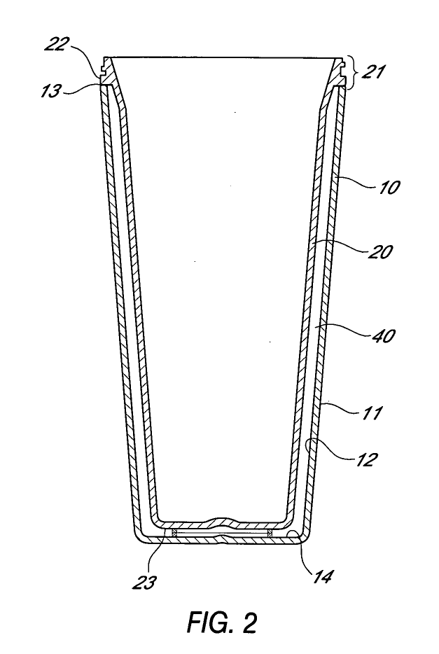

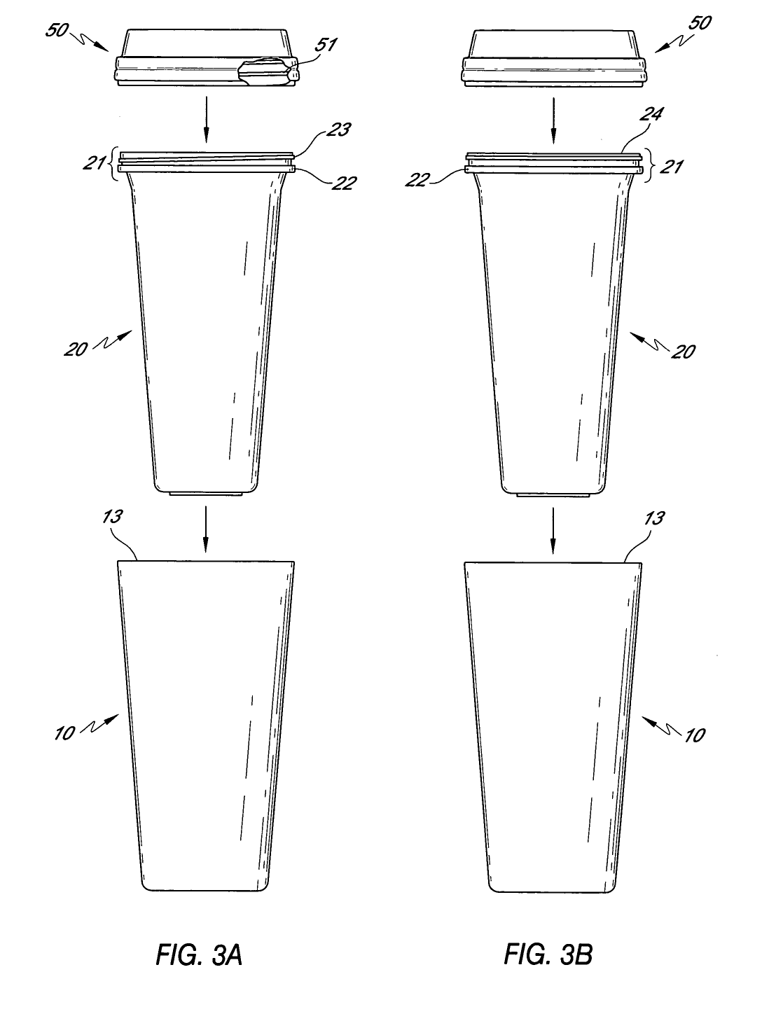

Referring to FIG. 1 and 2, the exterior bottom of the inner layer 23 may be attached to the interior bottom of the outer layer 14. Such an attachment may be achieved in various ways. For example, the exterior bottom of the inner layer 23 may be attached to the interior bottom of the outer layer 14 using a suitable adhesive, e.g., glue. This may help secure the inner layer 20 to the outer layer 10 and prevent the inner layer 20 from moving around in any gap 40 that may exist between the inner layer 20 and outer layer 10.

Referring to FIG. 1, an ornamental design may be applied by any suitable printing or silk-screening technique. The first portion of the ornamental design 30 may be applied to the outside of the outer layer 11 while the second portion of the ornamental design 31 is applied to the inside of the outer layer 12. For example, the first portion of the ornamental design 30 (shown as a circle with a broken line) may be applied to the outside of the outer layer 11 while the second portion of the ornamental design 31 (a solid opaque background) may be applied to the inside of the outer layer 12. The translucency of the outer layer 10 allows for both portions of the ornamental design to be viewed together from the outside. Moreover, by applying the first and second portions of the ornamental design in such a manner, a three-dimensional effect may be created where the first portion of the design 30, e.g., the circle, appears to floating above the second portion of the ornamental design 31, e.g., the opaque background.

In addition, as shown in FIG. 1, the beverage container 1 may further comprise a removable top cover 50. This allows for the beverage container 1 to be transported without spilling the liquid inside. The removable top cover 50 may be comprised of any suitable material(s), e.g., plastic. In one embodiment, the removable top cover 50 and at least a portion of the top of the inner layer 21 extending beyond the upper edge of the outer layer 13 comprise threads 23 and 51 that allow for the top cover 50 and the inner layer 20 to be joined. Alternatively, removable top cover 50 may snap onto the upper edge of the inner layer 24.

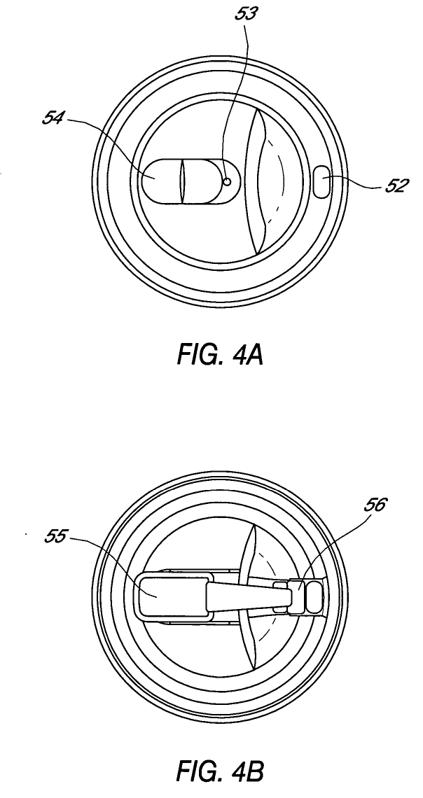

To enable an individual to drink from the covered beverage container, the removable top cover 50 may also include a dispensing aperture 52 and ventilation aperture 53 as shown in FIG. 1. The removable top cover 50 may also comprise a mechanism that opens and closes the dispensing aperture 52. There are various mechanisms that may be utilized. One example is shown in FIGS. 4A and 4B, wherein the mechanism may comprise two pieces, an upper piece 54 and a lower piece 55 which are located on the top and bottom of the removable top cover 50, respectively. To open and close the dispensing aperture 52, the upper piece 54 is manually moved towards or away from the dispensing aperture 52. The lower piece 55 moves with the upper piece 54 and includes a portion 56 that slides to either open or close the dispensing aperture 52. The aforementioned features may make the beverage container more suitable for carrying around and help prevent the spilling of the liquid inside the beverage container.

One skilled in the art would readily appreciate that the present invention is well adapted to carry out the objects and obtain the ends and advantages mentioned, as well as those inherent therein. The methods and procedures described herein are presently representative of preferred embodiments and are exemplary and are not intended as limitations on the scope of the invention. Changes therein and other uses will occur to those skilled in the art which are encompassed within the spirit of the invention.

It will be readily apparent to one skilled in the art that varying substitutions and modifications can be made to the embodiments disclosed herein without departing from the scope and spirit of the invention.

The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention. Thus, it should be understood that although the present invention has been specifically disclosed by certain inventive embodiments and optional features, modification and variation of the concepts herein disclosed can be resorted to by those skilled in the art, and that such modifications and variations are considered to be falling within the scope of the embodiments of the invention.

What is claimed is:

1. A beverage container, comprising:
a substantially cylindrical outer layer, wherein the outer layer is translucent;
a substantially cylindrical inner layer; and
an ornamental design comprising a first portion and a second portion, wherein the first portion is applied to the outside of the outer layer and wherein the second portion is applied to the inside of the outer layer.

2. The beverage container of claim 1, wherein the outer layer is made of plastic.

3. The beverage container of claim 2, wherein the plastic is chosen from the group consisting of polycarbonate, polyethylene, polyethylene terephthalate, polypropylene, polystyrene, polyvinyl chloride and mixtures thereof.

4. The beverage container of claim 1, wherein the outer layer is made of glass.

5. The beverage container of claim 1, wherein the inner layer is made of plastic.

6. The beverage container of claim 5, wherein the plastic is chosen from the group consisting of polycarbonate, polyethylene, polyethylene terephthalate, polypropylene, polystyrene, polyvinyl chloride and mixtures thereof.

7. The beverage container of claim 1, wherein the inner layer is made of glass.

8. The beverage container of claim 1, wherein the inner layer is transparent.

9. The beverage container of claim 1, wherein the inner layer is opaque.

10. The beverage container of claim 1, wherein at least a portion of the top of the inner layer extends beyond the upper edge of the outer layer.

11. The beverage container of claim 10, wherein at least a portion of the top of the inner layer extending beyond the upper edge of the outer layer is configured to engage the upper edge of the outer layer.

12. The beverage container of claim 10, wherein at least a portion of the top of the inner layer extending beyond the upper edge of the outer layer comprises a substantially cylindrical peripheral lip configured to engage the upper edge of the outer layer.

13. The beverage container of claim 1, wherein the exterior bottom of the inner layer is attached to the interior bottom of the outer layer.

14. The beverage container of claim 1, wherein the first portion of the ornamental design is applied by printing or silk-screening onto the outside of the outer layer.

15. The beverage container of claim 1, wherein the second portion of the ornamental design is applied by printing or silk-screening onto the inside of the outer layer.

16. The beverage container of claim 1, further comprising a removable top cover.

17. The beverage container of claim 16, wherein at least a portion of the top of the inner layer extending beyond the upper edge of the outer layer and the removable top cover comprise threads that allow for the removable top cover and the inner layer to be joined.

18. The beverage container of claim 16, wherein the removable top cover snaps onto the upper edge of the inner layer.

19. The beverage container of claim 16, wherein the removable top cover comprises a dispensing aperture and a ventilation aperture.

20. The beverage container of claim 19, wherein the removable top cover has a mechanism that opens and closes the dispensing aperture.

21. A beverage container, comprising;
a substantially cylindrical outer layer comprising plastic, wherein the outer layer is translucent;
a substantially cylindrical inner layer comprising plastic, wherein the exterior bottom of the inner layer is attached to the interior bottom of the outer layer; and
an ornamental design comprising a first portion and a second portion, wherein the first portion is applied to the outside of the outer layer and wherein the second portion is applied to the inside of the outer layer;
a removable top cover.
